(19) United States
(12) Patent Application Publication
(10) Pub. No.: US 2006/0155881 A1
(43) Pub. Date: Jul. 13, 2006

(54) Method for identification by a host computer avoiding collision of elements

(75) Inventor: Nicolas Pangaud, Valbonne (FR)

Correspondence Address: James C. Lydon, 100 Daingerfield Road, Suite 100, Alexandria, VA, 22314, US

(73) Assignee: ASK S.A., Valbonne (FR)

(21) Appl. No.: 10/472,066

(22) PCT Filed: Jan. 17, 2003
(86) PCT No.: PCT/FR03/00149

§ 371 Date: Nov. 18, 2004

(30) Foreign Application Priority Data
Jan. 17, 2002 (FR) 0200566

(51) Int. Cl. G06F 3/00

(52) U.S. Cl. 710/2

(57) ABSTRACT

An anti-collision process for elements controlled by a host computer allowing the identification of elements by the latter, each of the elements having an identification number between 0 and a maximum value (MAX), and including transmission by the host computer of a query instruction able to be received and recognized by all elements, transmission by the host computer of an anti-collision instruction including an identification attempt digital value, response by any element having an identification number less than or equal to the digital identification attempt value, and detection of a collision between several elements when the host computer receives several responses and transmissions of a new anti-collision instruction according to a given algorithm, or selection of the element by its identification number when there is only one response.

### TECHNICAL FIELD

This invention concerns systems in which several elements may be identified simultaneously by a host computer or an equivalent device designed to identify the elements thus resulting in a collision between several elements and specifically concerns an anti-collision process for elements to be identified by a host computer.

### PRIOR ART

Numerous systems exist in which a host computer or equivalent device is used to identify elements, each having an identification number and having a certain relationship with the host computer. This is the case when the elements are terminals which belong to the same data transmission network (“belongs to the same network” relationship), but also when the elements are contactless objects which allow access to a controlled access zone when they are identified by a reader (“close to the reader” relationship).

A significant problem which may occur in these systems lies in the fact that several elements may answer a query from the host computer or an equivalent device at the same time. This is the case, for example, when several contactless smart cards are presented in front of a reader simultaneously. A collision is said to have occurred between several elements. This problem must be solved by the reader which must be able to identify each of the elements involved in the collision.

In the case of contactless smart cards located within a given area in relation to the reader, known anti-collision processes implement tree-structured iterative algorithms in which all of the card identification numbers are represented according to a tree structure. In the latter, the tree's “root” divides into two “branches” each ending with a “knot” corresponding to the logical value 1 or 0 of a first bit of the identification number, for example, the most significant bit. These two knots each split into two new branches, both of which end with a knot corresponding to the value 1 or 0 of another bit of the identification number, and so on until the last bit of the identification number knowing that the tree has as many generations as there are bits used to encode the cards' identification numbers.

Anti-collision processes based on tree-structure iterative algorithms have the drawback of being slow insofar as the higher the number of bits are used to encode the identification number, the longer the exploration of the entire tree representing the card identification lasts. In this manner, in certain applications such as a mass transit network, a significant number of bits must be provided for in order to encode the identification numbers while in the majority of cases, only a very low number of cards are simultaneously presented in the area covered by the reader.

### DISCLOSURE OF THE INVENTION

As a result, the object of the invention is to produce an anti-collision process which is not based on the bit by bit comparison of identification numbers and thus does not require the identification of the bit which caused the collision, but which uses the positioning of each identification number in relation to an identification attempt digital value transmitted by the host computer using an algorithm enabling the collision to be solved rapidly.

This invention thus concerns an anti-collision process by a host computer of elements matching a given relationship with the host computer enabling the identification of elements by the latter, each of the elements having an identification number between 0 and a maximum value (MAX). This method includes the following steps:

a) transmission by the host computer of a query instruction capable of being received and recognized by any element matching the given relationship with the host computer,

b) when at least one element matches the given relationship with the host computer, the transmission by the latter of an anti-collision instruction including an identification attempt digital value,

c) response by any element matching the given relationship with the host computer and having an identification number less than or equal to the identification attempt digital value, and =p d) detection of a collision between several elements when the host computer receives several responses and in this case, transmission of an anti-collision instruction made up of an identification attempt digital value defined according to a given algorithm, or selection of the element by its identification number when there is only one response.

According to a preferred embodiment, the elements are contactless smart cards such as access cards to controlled access zones, which are identified by passing the card in a specific area in front of a reader acting as the host computer.

### BRIEF DESCRIPTION OF THE DRAWINGS

The purposes, objects and characteristics of the invention will become more apparent from the following description when taken in conjunction with the accompanying drawings in which:

FIG. 1 represents a block diagram of the process according to the invention implemented in each element and namely the chip of a contactless smart card when it is presented in front of a reader, and

FIG. 2 represents a block diagram of the process according to the invention implemented in the host computer and namely the identification of contactless smart cards.

### DETAILED DESCRIPTION OF THE INVENTION

The invention's process may be implemented in any system in which several elements are in a given relationship with a host computer. However, in the description that follows, the process is described in a preferred embodiment where the elements are contactless smart cards communicating with a reader when they are located in a space defined in relation to the reader.

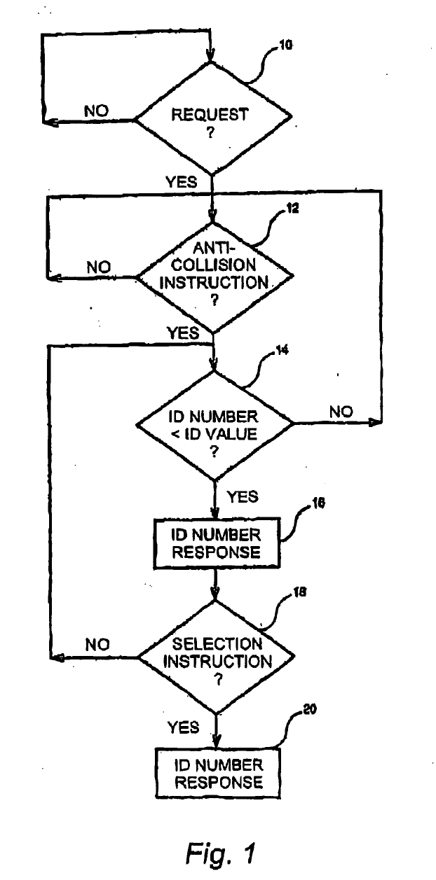

In reference to FIG. 1, any card located within the space defined in relation to the reader is expected to receive a query from the reader, this query being transmitted in a cyclic manner by said reader (for example, every 5 ms). Consequently, each card checks that it receives the query (step 10), this step being continuously repeated until the query is received.

When the query has been received by the card's chip, the latter waits for an “anti-collision” instruction from the reader (step 12) and loops back until the instruction is received. When the anti-collision instruction is received, the chip checks that its own identification number is less than or equal to an identification attempt digital value contained in the instruction (step 14). If this is not the case, the process loops back to wait for an anti-collision instruction. It should be noted that all the cards which receive the query participate in the anti-collision process and that the cards connected after this query has been sent do not participate in order to prevent all disturbance by the new cards.

If the card's identification number is less than or equal to the digital value contained in the instruction, the card's chip responds to the reader by sending it its identification number (step 16).

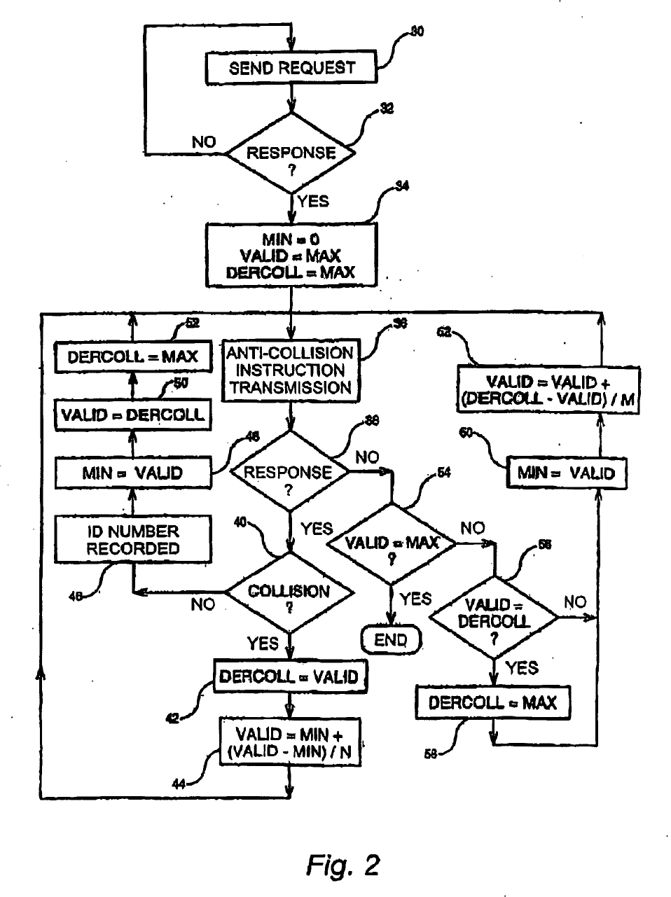

Then, the chip waits for a new instruction; this instruction may be a selection instruction or a new anti-collision instruction (step 18). If the instruction received is a new anti-collision instruction, the process loops back to step 14 to check that the card's identification number is less than the identification attempt digital value contained in the new instruction. It should be noted that the above relooping process of steps 14 and 16 may be repeated several times as described below, in reference to FIG. 2.

Although, in the embodiment described in reference to FIGS. 1 and 2, the fundamental principle of the invention is to check if the card's identification number is less than or equal to an identification attempt value, it would also be possible to check if the card's identification number is less than or equal to an identification attempt value without deviating from the scope of the invention.

If the card receives a selection instruction, this means that it has been identified. The chip once again transmits its identification number to the reader (step 20) and no longer participates in the anti-collision process.

The anti-collision process implemented in the reader takes place as described below in reference to FIG. 2. Firstly, the reader sends a query (step 30) to all the cards located within a space defined in relation to the reader. The reader waits for at least one response from a card (step 32) and loops back as long as a response is not received. When a response is received, several variables are initialized (step 34); a MIN variable, which designates the lower limit of the interval in which the identification numbers to be identified are located, is initialized to 0; VALID representing the identification attempt digital value is initialized to MAX which is the highest value held by the identification number assigned to the card and DERCOLL is the variable representing the last VALID value used in the process and also initialized to MAX.

Then, an anti-collision instruction containing an identification attempt digital value is transmitted by the reader (step 36). After this transmission, the reader waits for a possible response (step 38). If a response is received, this means that there is at least one card in the space defined where communication can take place with the reader. The reader must determine if a collision has occurred or if there is only one single response, that is to say a single card in the defined space (step 40).

When a collision occurs, the DERCOLL variable is set to the VALID value (step 42), that is the identification attempt digital value used in the preceding anti-collision instruction, and the VALID value is modified by taking into account the parameter N, referred to as the down speed which is greater than 1 (step 44), in the following manner:
VALID=MIN+(VALID−MIN)/N

before the process is looped back to step 36 where a new anti-collision instruction is transmitted. It should be noted that, owing to the use of this first algorithm, the new value of VALID is necessarily less than the previous. This way, with N=2 and MAX=1,000, the value of VALID would be brought to 500.

When no collision occurs, this means that there was only one response. In this case, the card's identification number is recorded by the reader (step 46) so as to enable it to select the card as seen previously. The MIN value is modified and brought” to VALID (step 48), the value of VALID is brought to the DERCOLL value (step 50), and the DERCOLL value is replaced by MAX (step 52), before looping back the process on the new anti-collision instruction transmission step. It should be noted that this second algorithm allows the VALID value to be increased to the MAX value and to be able to identify cards whose identification numbers are located in intervals near MAX and which have not yet been detected because they were in collision with identification numbers located in lower intervals.

When there is no response following the transmission of the anti-collision instruction of step 38, this does not mean that all the identification numbers of cards present were detected. It is possible that identification numbers are located in an interval near MAX while there are no more identification numbers lower than VALID.

If there is no response, a check is first made to see if the value of VALID has reached MAX (step 54). If this is the case, it is certain that there are no more cards to identify and the process is terminated. Otherwise, a verification is made to determine if VALID is equal to DERCOLL (step 56). If this is the case, the value of DERCOLL is set equal to MAX (step 58). In both examples, the value of MIN is set equal to,the value of VALID (step 60) and the value of VALID is modified while considering a parameter M, referred to as the up speed, which is larger than 1 (step 62) in the following manner:

before the process is looped back to step 36 where a new anti-collision instruction is transmitted. It should be noted that, owing to the use of this third-algorithm, the new value of VALID is necessarily greater than the previous.

The anti-collision process described above is very rapid insofar as the probability to detect a card with few instructions is significant. In this manner, supposing that three card whose identification numbers are A, B, C, respectively, are involved in the collision process, there are 8 possible cases of separation of the range 0-MAX by the digital value VALID (after a single anti-collision instruction), shown in the following table:

| | | | | | | | | |
|---|---|---|---|---|---|---|---|---|
| >VALID | A, B, C | A, B | A, C | B, C | A | B | C | |
| VALID | | C | B | A | B, C | A, C | A, B | A, B, C |
| Anti- | No | Yes | Yes | Yes | No | No | No | No |
| collision | | | | | | | | |
| successful | | | | | | | | |

There are thus 2 chances out of 8 (0.25) to have the 3 identification numbers unseparated by VALID, 3 chances out of 8 (0.375) to have another 2 identification numbers to be separated, and 3 chances out of 8 (0.375) to have identified a card. To know the probabilities after two instructions, the mixed combinations must be added to this last digit.

The probability to determine an identification number in two instructions is thus:
P=0.375+ 2/8×⅜+⅜×½=0.656

In this manner, a table can be established which gives the probability to determine an identification number among Y identification numbers in X instructions, X being between 1 and 12 and Y being between 2 and 12.

| | X | | | | | | | | | | | |
|---|---|---|---|---|---|---|---|---|---|---|---|---|
| Y | 1 | 2 | 3 | 4 | 5 | 6 | 7 | 8 | 9 | 10 | 11 | 12 |
| 2 | 0.500 | 0.750 | 0.875 | 0.938 | 0.969 | 0.984 | 0.992 | 0.996 | 0.998 | 0.999 | 1.000 | 1.000 |
| 3 | 0.375 | 0.656 | 0.820 | 0.908 | 0.954 | 0.977 | 0.988 | 0.994 | 0.997 | 0.999 | 0.999 | 1.000 |
| 4 | 0.250 | 0.563 | 0.766 | 0.879 | 0.938 | 0.969 | 0.984 | 0.992 | 0.996 | 0.998 | 0.999 | 0.999 |
| 5 | 0.156 | 0.479 | 0.714 | 0.850 | 0.924 | 0.961 | 0.981 | 0.990 | 0.995 | 0.998 | 0.999 | 0.999 |
| 6 | 0.094 | 0.404 | 0.664 | 0.822 | 0.909 | 0.954 | 0.977 | 0.988 | 0.994 | 0.997 | 0.999 | 0.999 |
| 7 | 0.055 | 0.339 | 0.617 | 0.795 | 0.894 | 0.946 | 0.973 | 0.986 | 0.993 | 0.997 | 0.998 | 0.999 |
| 8 | 0.031 | 0.283 | 0.572 | 0.768 | 0.880 | 0.939 | 0.969 | 0.984 | 0.992 | 0.996 | 0.998 | 0.999 |
| 9 | 0.018 | 0.234 | 0.530 | 0.742 | 0.865 | 0.931 | 0.965 | 0.983 | 0.991 | 0.996 | 0.998 | 0.999 |
| 10 | 0.010 | 0.193 | 0.490 | 0.717 | 0.851 | 0.924 | 0.961 | 0.981 | 0.990 | 0.995 | 0.998 | 0.999 |
| 11 | 0.005 | 0.158 | 0.453 | 0.692 | 0.837 | 0.916 | 0.958 | 0.979 | 0.989 | 0.995 | 0.997 | 0.999 |
| 12 | 0.003 | 0.128 | 0.418 | 0.668 | 0.823 | 0.909 | 0.954 | 0.977 | 0.988 | 0.994 | 0.997 | 0.999 |

From the table above, it is clear that the probability to determine an identification number after few instructions is high. For example, there are more than 9 chances out of 10 to find 1) an identification number among 2 or 3 numbers in 4 instructions, 2) an identification number among 4, 5, or 6 numbers in 5 instructions and 3) an identification number among 7, 8, 9, 11, or 12 numbers in 6 instructions.

Generally speaking, it is best that the up and down speed numbers N and M are selected in such a way that one of them is at least greater than or equal to 2. In addition, experience has shown that the result is optimal if N and M are both equal to 2.

In an attempt to illustrate the invention, the examples below are given in which the identification number of each card is analyzed over 16 bits which means that the identification numbers are between 0 and 65.536. It is also supposed that M=N=2 and that each instruction lasts 1.5 ms. If we consider an initial time due to the transmission of the query and its response, the maximum time needed to detect between 1 and 12 identification numbers is thus:

| | | | | | | | | | | | | |
|---|---|---|---|---|---|---|---|---|---|---|---|---|
| Number of | 1 | 2 | 3 | 4 | 5 | 6 | 7 | 8 | 9 | 10 | 11 | 12 |
| numbers | | | | | | | | | | | | |
| Maximum | 2 | 30 | 39 | 50 | 59 | 66 | 73 | 82 | 87 | 99 | 104 | 112 |
| time (ms) | | | | | | | | | | | | |

| | X | | | | | | | | | | | |
|---|---|---|---|---|---|---|---|---|---|---|---|---|
| Y | 1 | 2 | 3 | 4 | 5 | 6 | 7 | 8 | 9 | 10 | 11 | 12 |
| 2 | 0.500 | 0.750 | 0.875 | 0.938 | 0.969 | 0.984 | 0.992 | 0.996 | 0.998 | 0.999 | 1.000 | 1.000 |
| 3 | 0.375 | 0.656 | 0.820 | 0.908 | 0.954 | 0.977 | 0.988 | 0.994 | 0.997 | 0.999 | 0.999 | 1.000 |
| 4 | 0.250 | 0.563 | 0.766 | 0.879 | 0.938 | 0.969 | 0.984 | 0.992 | 0.996 | 0.998 | 0.999 | 0.999 |
| 5 | 0.156 | 0.479 | 0.714 | 0.850 | 0.924 | 0.961 | 0.981 | 0.990 | 0.995 | 0.998 | 0.999 | 0.999 |
| 6 | 0.094 | 0.404 | 0.664 | 0.822 | 0.909 | 0.954 | 0.977 | 0.988 | 0.994 | 0.997 | 0.999 | 0.999 |
| 7 | 0.055 | 0.339 | 0.617 | 0.795 | 0.894 | 0.946 | 0.973 | 0.986 | 0.993 | 0.997 | 0.998 | 0.999 |
| 8 | 0.031 | 0.283 | 0.572 | 0.768 | 0.880 | 0.939 | 0.969 | 0.984 | 0.992 | 0.996 | 0.998 | 0.999 |
| 9 | 0.018 | 0.234 | 0.530 | 0.742 | 0.865 | 0.931 | 0.965 | 0.983 | 0.991 | 0.996 | 0.998 | 0.999 |
| 10 | 0.010 | 0.193 | 0.490 | 0.717 | 0.851 | 0.924 | 0.961 | 0.981 | 0.990 | 0.995 | 0.998 | 0.999 |
| 11 | 0.005 | 0.158 | 0.453 | 0.692 | 0.837 | 0.916 | 0.958 | 0.979 | 0.989 | 0.995 | 0.997 | 0.999 |
| 12 | 0.003 | 0.128 | 0.418 | 0.668 | 0.823 | 0.909 | 0.954 | 0.977 | 0.988 | 0.994 | 0.997 | 0.999 |

From the table above, it is clear that the probability to determine an identification number after few instructions is high. For example, there are more than 9 chances out of 10 to find 1) an identification number among 2 or 3 numbers in 4 instructions, 2) an identification number among 4, 5, or 6 numbers in 5 instructions and 3) an identification number among 7, 8, 9, 10, 11, or 12 numbers in 6 instructions.

Generally speaking, it is best that the up and down speed numbers N and M are selected in such a way that one of them is at least greater than or equal to 2. In addition, experience has shown that the result is optimal if N and M are both equal to2.

In an attempt to illustrate the invention, the examples below are given in which the identification number of each card is analyzed over 16 bits which means that the identification numbers are between 0 and 65.536. It is also supposed that M=N=2 and that each instruction lasts 1.5 ms. If we consider an initial time due to the transmission of the query and its response, the maximum time needed to detect between 1 and 12 identification numbers is thus:

| | | | | | | | | | | | | |
|---|---|---|---|---|---|---|---|---|---|---|---|---|
| Number of | 1 | 2 | 3 | 4 | 5 | 6 | 7 | 8 | 9 | 10 | 11 | 12 |
| numbers | | | | | | | | | | | | |
| Maximum | 2 | 30 | 39 | 50 | 59 | 66 | 73 | 82 | 87 | 99 | 104 | 112 |
| time (ms) | | | | | | | | | | | | |

### EXAMPLE 1

### 4 Cards

MAX=1,000

Identification numbers of the 4 cards involved in a collision:

ID1=12 ID2=356 ID3=567 ID4=568

1 VALID=1000 MIN=0 DERCOLL=1000→collision

2 VALID=500 MIN=0 DERCOLL=1000→collision

3 VALID=250 MIN=0 DERCOLL=500→one response: 0012

[symbol]

6 VALID=750 MIN=500 DERCOLL=1000→collision

7 VALID=625 MIN=500 DERCOLL=750→collision

8 VALID=563 MIN=500 DERCOLL=625→pas de réponse

9 VALID=594 MIN=563 DERCOLL=625→collision

10 VALID=579 MIN=563 DERCOLL=594→collision

11 VALID=571 MIN=563 DERCOLL=579→collision

12 VALID=567 MIN=563 DERCOLL=571→one response: 0567

13 VALID=571 MIN=567 DERCOLL=1000→one response: 0568

14 VALID=1000 MIN=571 DERCOLL=1000→No response

Fourteen instructions and 28.5 ms were needed to detect the 4 identification numbers.

### EXAMPLE 2

### 5 Cards

MAX=1,000

Identification numbers of 5 cards in collision:

ID1=887 ID2=997 ID3=938 ID4=562 ID5=294

1 VALID=1000 MIN=0 DERCOLL=1000→collision

2 VALID=500 MIN=0 DERCOLL=1000→one response: 0294

3 VALID=1000 MIN=500 DERCOLL=1000→collision

4 VALID=750 MS=500 DERCOLL=1000→one response: 0562

5 VALID=1000 MIN=750 DERCOLL=1000→collision

6 VALID=875 MIN=750 DERCOLL=1000→No response

7 VALID=938 MIN=875 DERCOLL=1000→collision

8 VALID=907 MIN=875 DERCOLL=938→one response: 0887

9 VALID=938 MIN=907 DERCOLL=1000→one response: 0938

10 VALID=1000 MIN=938 DERCOLL=1000→one response: 0997

11 VALID=1000 MIN=1000 DERCOLL=1000→No response

Eleven instructions and 25.5 ms were needed to detect the 5 identification numbers.

In its application to contactless smart cards, the process according to the invention described above uses the communication means in compliance with standard ISO 14443. However, contrary to existing procedures, identification of the bit that caused the collision is not required as the collision is deduced from the erroneous “checksum”. It is not dependant on the time and can thus be implemented as software in BASIC language on a PC or hard-coded in the reader without impacting the functionality of the process.

Whether it be in each element, a contactless smart card for example, or in the host computer or equivalent such as the contactless smart card reader, the process according to the invention is implemented through a software code, namely a computer program.

1. An anti-collision process by a host computer of elements matching a given relationship with said host computer enabling the identification of said elements by the latter, each of said elements having an identification number between 0 and a maximum value (MAX);
said process being characterized by the following steps:
a) transmission by said host computer of a query instruction capable of being received and recognized by any element matching said given relationship with said host computer,
b) when at least one of said elements matches said given relationship with said host computer, transmission by the latter of an anti-collision signal including an identification attempt digital value,
c) response by any element matching said given relationship with said host computer and having an identification number less than or equal (or greater than or equal) to said digital identification attempt value, and
d) detection of a collision between several elements when said host computer receives several responses and in this case, transmission of an anti-collision instruction made up of an identification attempt digital value defined according to a given algorithm, or selection of the element by its identification number when there is only one response.

2. The anti-collision process by a host computer of elements matching a given relationship with said host computer enabling the identification of said elements by the latter, each of said elements having an identification number between 0 and a maximum value (MAX);
said process being characterized by the following steps:
a) transmission by said host computer of a query instruction capable of being received and recognized by any element matching said given relationship with host computer,
b) when at least one of said elements matches said given relationship with said host computer, transmission by the latter of an anti-collision instruction including an identification attempt digital value,
c) transmission by said host computer of a new anti-collision instruction including an identification attempt digital value less than the identification attempt digital value transmitted earlier and resulting from an initial algorithm if there is a collision between the responses coming from several of said elements or recording of the identification number of the element by said host computer when only one element exists whose identification number is less than said identification attempt digital value transmitted earlier,
d) repetition of step c) until the transmission of an anti-collision instructions made up of an identification attempt digital value leading to the identification of only one of said elements, and in this case, the recording of the identification number of said element,
e) transmission by said host computer of a new anti-collision instruction including an identification attempt digital value greater than the identification attempt digital value transmitted earlier and resulting from a second algorithm if there is a collision between the responses coming from several of said elements or recording of the identification number of the element by said host computer when only one element exists whose identification number is less than said identification attempt digital value transmitted earlier,
f) repetition of step e) until the transmission of an anti-collision instruction including said maximum value as the identification attempt digital value, and
g) repetition of steps c) through f) until the transmission of an anti-collision instruction including said maximum value as the identification attempt digital value results in no response from said elements.

3. The process according to claim 2, including the following steps if there is no response to the anti-collision instruction of steps c) and e)
h) verification that said anti-collision instruction does not include said maximum value as the identification attempt digital value,
i) transmission by said host computer of a new anti-collision instruction including an identification attempt digital value greater than the identification attempt digital value transmitted earlier and resulting in a third algorithm, and
j) repetition of steps c) through g).

4. The process according to claim 3, in which said first algorithm consists in replacing the identification attempt digital value VALID contained in the anti-collision instruction by the new value:
VALID=MIN+(VALID−MIN)/N
in which MIN designates the lower value of an interval, the upper value of which is VALID and in which are located the identification numbers of the elements to be identified and N designates a down speed parameter whose value is greater is greater than 1.

5. The process according to claim 4, in which said second algorithm consists in replacing MIN by the identification attempt digital value (VALID) contained in the anti-collision instruction which was just transmitted and in replacing said identification attempt digital value by the identification attempt digital value contained in the anti-collision instruction preceding said anti-collision instruction which was just transmitted.

6. The process according to claim 5, in which said third algorithm consist in replacing the digital identification attempt value VALID contained in the anti-collision instruction by the new value:
VALID=VALID+(DERCOLL−VALID)/M
in which DERCOLL is a variable whose value is equal to MAX or to the identification attempt digital value of the anti-collision instruction preceding the anti-collision instruction which was just transmitted and M designates an up speed parameter having a value greater than 1.

7. The process according to claim 2, in which each of the variable M and N is equal to 2.

8. The process according to claim 1, in which said elements are contactless smart cards and said host computer is a reader of said contactless smart cards.

9. A computer program including instructions implementing the process according to claim 1.

10. A computer program including instructions implementing the process according to claim 2.
